(19) United States
(12) Patent Application Publication
(10) Pub. No.: US 2010/0064524 A1
(43) Pub. Date: Mar. 18, 2010

(54) Vibrating peeler

(76) Inventors: Pat Y. Mah, Kowloon (HK); Alexander Joseph Kalogroulis, Coulsdon (GB)

Correspondence Address: CURTIS L. HARRINGTON, 6300 STATE UNIVERSITY DRIVE, SUITE 250, LONG BEACH, CA, 90815, US

(21) Appl. No.: 12/284,092

(22) Filed: Sep. 17, 2008

(51) Int. Cl. B26B 11/00

(52) U.S. Cl. 30/123.5

(57) ABSTRACT

A vibrating peeler uses a vibrator in the form of a more powerful motor plus larger weight and within an inner housing. The inner housing is placed in an outer housing and a damper is placed between the outer handle and inner housing. Several embodiments are shown for blade loading. An alternative embodiment light weight eccentric which drives a heavier mass, but only back and forth rather than a circular pattern. This vibrating arrangement puts more lateral motion to the blade, and avoids other motion in directions not parallel to the blade.

### FIELD OF THE INVENTION

The present invention relates to an improvements in the design and operation of a vibrating peeler which facilitates the ability for users to achieve greater control in peeling, especially of food, which will result in less waste both in control of removal of a thinner section of the layer to be peeled, as well as a reduction in the amount of damage to the food.

### BACKGROUND OF THE INVENTION

Generally, portable vibrating peelers are known to facilitate the task of peeling skin from vegetables and fruit. One design has a blade that moves backwards and forwards in a sawing action, with the reciprocating action can be driven by a motor via a crank mechanism, or a cam mechanism of a wobble plate cam mechanism. A different arrangement uses a motor that oscillates a blade in a small arc via a gearbox and crank. Both of these arrangements suffer from a number of shortcomings. Noise generated through gear trains, cams and contact between vibrating surfaces is a significant problem. The use of small, high speed motors (necessitated due to the small dimensions of portable peelers) also generates noise at a higher pitch relative to the human ear. In addition, these arrangements require a shaft to pass from the dry, motor/gearbox area of the product into the wet area of the peeling blade.

Also on the market are vibrating toothbrushes and vibrating wet razors. These use a different approach in which a small, high speed motor with an eccentric mass fitted to the shaft is used to produce vibration by small changes in mass. The motor rotation therefore creates a vibration that is transmitted through the entire product. This vibration is therefore imposed upon the hand of the user who is holding the implement. Thus the hand of the user is used to both damp the vibration as well as being somewhat irritated by it. The vibrations that are needed by a toothbrush or razor are quite small so the vibrations felt by the hand are acceptable.

### SUMMARY OF THE INVENTION

A vibrating peeler uses a vibrator in the form of a more powerful motor plus larger weight and within an inner housing. The inner housing is placed in an outer housing and a damper is placed between the outer handle and inner housing. Careful positioning and design of the damper then allows the inner housing to move relative to the outer handle. In this way a powerful yet quiet vibrating motor/eccentric can be comfortably held in the hand.

By placing the damper at the opposite end to the vibrator, with the peeler blade near the vibrator and away from the damper, a large cutting amplitude can be attained, but with very limited vibration being transmitted to the outer handle. In a second embodiment, in lieu of a damper, a pivot is placed between the outer handle and the inner housing. This pivot transfers only approximately half of the vibrations to the outer handle with the other half of the vibrations being relatively unconstrained.

In a further modification to the vibrating motor/eccentric, a lightweight eccentric cam is used to drive an oscillating weight to change the amplitude of vibrations in different directions. The peeler of the invention includes both peeler arms and blade, to enable the blade to be released by pressing the peeler arms together in one possible embodiment. An alternative lever arm design can utilize added levers are added to allow the levers to be squeezed to transmit force to the peeler arms to cause a previously restrained blade to be released. A further alternative includes a light weight eccentric which drives a heavier mass, but only back and forth rather than a circular pattern. This vibrating arrangement puts more lateral motion to the blade, and avoids other motion in directions not parallel to the blade.

### BRIEF DESCRIPTION OF THE DRAWINGS

The invention, its configuration, construction, and operation will be best further described in the following detailed description, taken in conjunction with the accompanying drawings in which:

FIG. 1 is a perspective view illustrating the exterior overall shape of the vibrating peeler, but with the left half of the handle housing broken away to illustrate the component parts within the handle;

FIG. 2 is an expanded and detailed view of the rear of the peeler illustrating a further broken away view of the rear of the peeler handle to reveal details of the damper;

FIG. 3 is a view similar to that seen in FIG. 1 but illustrating an alignment and securing of the rear eye remover which operates to secure the damper;

FIG. 4 is a front view showing some of the internals of the vibration portion of the motor housing with the battery housing shown rearwardly in exploded view and illustrating the threaded member with which the battery housing is connected to the motor housing;

FIG. 5 is a view looking into the rear of the forward housing with blade holder arms attached and illustrating the rear threads and battery contact to enable the forward housing to be connected physically and electrically to the battery housing;

FIG. 6 is a perspective view looking down upon a further embodiment of the vibrating peeler in which the blade holder arms have rearwardly extending spread levers to spread the arms apart to release the pivoting double blade;

FIG. 7 illustrates an alternative embodiment illustrating blade release by pressing the pivot arms together and which utilize cylindrical members inboard of expanded head members which fit within bosses on the outside of the arms;

FIG. 8 is a perspective view of a motor having a weight to predominantly produce vibration in a side to side motion;

FIG. 9 is a side sectional view of a third embodiment which can utilize the motor arrangement seen in FIG. 7 and which uses a pivoting action about a vertical axis; and

FIG. 10 is a perspective external view of the third embodiment and illustrating some of the features seen in FIGS. 8 and 9.

### DETAILED DESCRIPTION OF THE PREFERRED EMBODIMENT

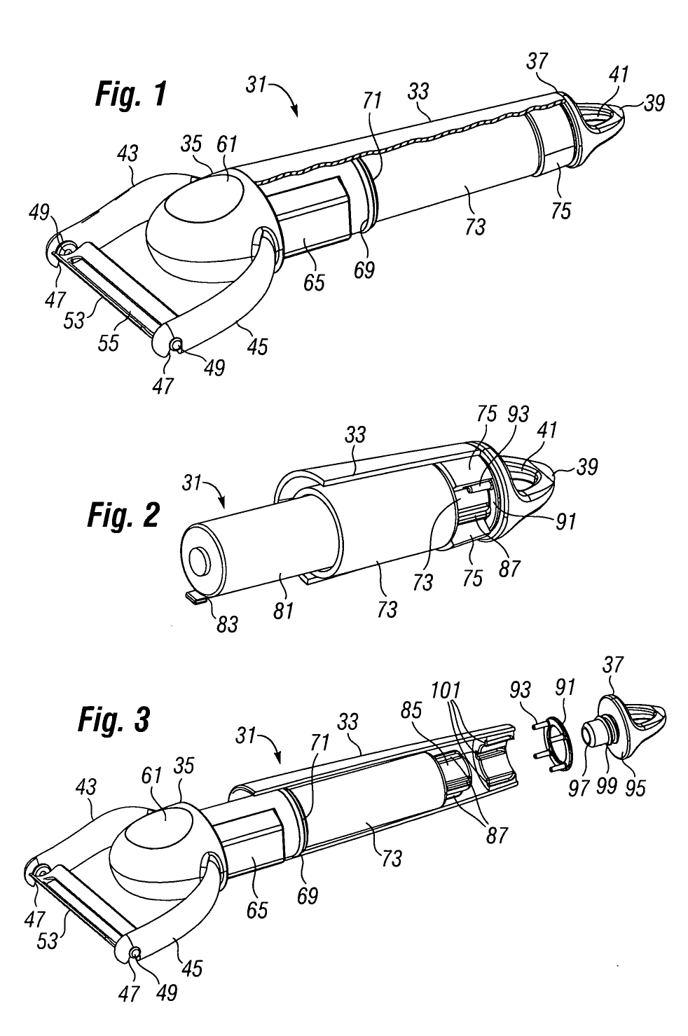

The description and operation of the vibrating peeler of the invention is best begun with reference to FIG. 1 which illustrates is a perspective view illustrating the exterior overall shape of a vibrating peeler 31. The vibrating peeler 31 has a handle member 33 connected to a forward housing 35 at a front end of the handle member and securing an end closure 37 having a vegetable eye remover 39 structure at the rear of the handle member 33. The vegetable eye remover 39 is shown as having a through opening 41, which enables the vegetable eye remover 39 structure to double as an attachment structure.

At the forward housing 35, a pair of arms, including a right arm 43 and a left arm 45. Arms 43 and 45 extend laterally curvingly away from the forward housing 35 and terminate after some parallel extent. At each of the ends of the arms 43 and 45 is a downwardly directed slot 47. Roughly seen within the slot are a pair of blade pivots 49. As can be seen the blade pivots have an expanded diameter portion at the insides or facing portions of the ends of the arms 43 and 45, of which further details will be shown. Generally, a watertight joint is formed between the arms 43 and 45 and the forward housing 35 by integral formation, ultrasonic welding, solvent welding or a similar means.

A double blade 53 having a central slot 55 has sharpened edges on either side of the central slot 55 so that peeling can be accomplished in either a forward or rearward direction. The interaction of the pair of blade pivots 49 and the arms 43 will be such as to allow the double blade 53 to pivot, but may be arranged to maintain it generally within an angular positional constraint if desired.

The pivots 49 can be attached to the double blade 53 by over molding, bonded, press fit or attached in any other suitable fashion. When clipped in, there is light pressure on the face of the flanges 49 to ensure that the vibrations of the arms 43 and 45 of the vibrating peeler 31 are efficiently transmitted to the double blade 53 itself. The double blade 53 is free to pivot to suit the surface of any food or other object being peeled. To remove the double blade 53, either end may be un-clipped first by applying downward pressure to the arms 43 and 45. A safety cover (not shown) can be placed over the blade for further safe handling during blade removal/insertion. As will be seen, two other blade removal structures will be shown which can facilitate removal of the double blade 53 also by spreading of the arms 43 and 45 and by compression of the arms 43 and 45.

At the top of the forward housing 35 is an on/off button 61. The on/off button 61 will preferably press to turn and leave on action and a push to turn off so that the user may be position their hands on the handle 33 for optimum comfort and view of the peeling operation. The central and upper location of the on/off button 61 will permit it actuation by thumb and enable the user to actuate the vibrating peeler 31 on and off without the necessity to bring any part of the user's hands forward of the center of the forward housing 35 and to easily avoid placing the hands anywhere near blade 53 while actuating the vibrating peeler 31 on and off.

Also seen in FIG. 1 are the main sections of the vibrating peeler sue to the broken away section of main handle section 31, including a motor housing 65, an “o” ring seal 69, a battery housing flange 71, and a battery housing 73. The battery housing flange 71 helps create pressure on the an “o” ring seal 69 and against the motor housing 65. Further, the “o” ring seal 69 acts as a secondary dampener to absorb any excess noise and to help eliminate vibration in the structures between which it is located. To the rear of battery housing 73 a damper 75 is partially seen. The location of the battery housing to the rear of the vibrating peeler 31 helps to leverage the bulk of the vibratory motion to the forward end of the vibrating peeler 31. In general, damper 75 may be attached to the handle member 33 by over molding (preferred), bonding, or mechanical interlock means. The forward housing 35 and the motor housing 56 form a sealed unit as a main housing.

Referring to FIG. 2, an expanded and detailed view of the rear portion of the peeler at and rearward of the battery housing 73 illustrates further details. As can be seen, a battery 81 is seen above a conductor strip 83 which is used to bring current up from the rear of the battery 81 in the battery housing 73 (not seen in FIG. 2), or from the last battery in a line of batteries, if more than one battery 81 were present. At the rear of the battery housing 73 a number of structures are seen partially broken away. A projection 85 extends rearwardly of and may or may not be an integral part of the battery housing 73 and is used to set the radial dimension between the internal structure at the rear of the battery housing 73 and its interaction with the damper 75. Projection 85 also carries a set of internal threads for engaging the end closure 37.

The rear projection 85 may have a series of radially extending locating ribs 87. Locating ribs 87 may interfit and be located within grooves or other accommodating structure within the damper 75, as will be shown. Also seen is a damper washer 91 which has a series of projections 93 which may penetrate the damper 75 through pre-formed bores. The damper washer helps to form a good seal between end closure 37 and end closure's attachment into the projection 85. The projections help to control the movement and relationship of the damper washer 91.

Referring to FIG. 3, a view similar to that seen in FIG. 1 but from a less expanded perspective illustrates the removability of the motor housing 65 and battery housing 73 as a unit from the handle member 33 upon removal of the end closure 37. The end closure 37 is seen to have a forward facing wall 95 surrounding a plug projection 97 carrying one or more threads 99 for engaging a matching thread set inside the projection 85.

Ideally, damper 75 may be attached to the inside surface of handle member 33, welding, adhesive and more. End closure 37 screws into the end projection 85 which may preferably be formed with and an integral part of the battery housing 73. Damper 75, with damper washer 91 in place, becomes trapped between the battery housing 73 and the end closure 37. Tightening the end closure 37 into the projection 85 makes the damper 75 compress a bit and can adjust the damping. Damper washer 91 allows end closure 37 to turn easily without friction dragging directly onto the rubber damper.

Damper 75, in this exploded view, is seen to have a number of slots or grooves 101 (of which three are seen) for interfitting with the series of radially extending locating ribs 87 on the projection 85. Projection 85 slides into the damper 75 aligned by ribs 87 and slots or grooves 101. Damper washer 91 is placed adjacent the damper 75 with pins or projections 93 either into matching bores or if the projections 93 are small enough, simply pressed into the damper 75 form the stabilizing barrier against the turning of the end projection 37.

As can be seen at the front of the vibrating peeler 31, the end closure 37 holds the motor housing 65 and battery housing 73 and all structures forward of the motor housing 65 as a unitary assembly within the handle member 33. Removal of the end closure 37 allows the handle member 33 to be removed and the vibrating peeler 31 disassembled.

Referring to FIG. 4, a front view showing some of the internals of the vibration portion of the motor housing 65 is seen, with the battery housing 73 shown rearwardly in exploded view with the battery 83 shown in place. Beginning with the battery housing, just forward of the “o” ring seal 69 a threaded section 105 is seen. Threaded section 105 is on the outside surface of a wall 107 which forms an entrance to the hollow inside of the battery housing 73. The threaded section 105 will be seen to form the structure with which the battery housing 73 is attached to the motor housing 65.

The enclosing wall of the forward housing 35 is partially broken away to reveal details of the components located there. A front wall 111 has an opening through which a motor 113 is partially seen as being located behind the front wall 111. However forward housing 35 and motor housing 65 together form a waterproof enclosure which isolates all of the internal components seen in FIG. 4 from water entry. A shaft 115 of the motor can be seen within an eccentric weight 117, such the eccentric arrangement is a rotary moving mass. The vibration for the vibrating peeler 31 occurs because of the weight of the eccentric weight 117 turning on the shaft 115. Because the center of weight of the eccentric located away from the shaft 115, turning of the shaft with its off balance eccentric weight 117 causes a circular vibration in the vicinity of the double blade 53 at the ends of the arms 43 and 45 seen in FIGS. 1 and 3.

As can be particularly seen in FIG. 4, the center of gravity of the vibrating peeler 31, given the presence of the battery 81 and motor (not shown) within motor housing 5, will probably lie somewhere along the length of the battery 81, but very likely to be located at the rear of the motor housing 65. Thus, even without damping, the handle member 33 will vibratably orbit about a center of gravity pivot within the handle member 33.

The arms 43 and 45 are seen to possibly be molded with the forward housing 35. The forward housing 35 has an internal space 125 which houses, in addition to the eccentric weight 117 and shaft 115, a number of other structures are shown. A switch 127 has an actuation button 129 which lies underneath a lever 131. Lever 131 underlies an over molded button 133. Lever 131 is attached at a pivot attachment 135. Adequate spacing and clearance is provided about the eccentric weight 117 for rotational clearance.

Further details of the blade pivot 49 is seen where the arm 45 has been removed for clarity. Pivot 49 has a small diameter cylindrical member 141 and an expanded head 143. The head 143 stabilizes and spreads the force from the arms 43 and 45 which are pre-stressed to place force against the outwardly exposed surfaces of the heads 143 of the blade pivots 49. The angle of pivot may or may not be limited by the shape and other features of the blade pivots 49. Since the double blade 53 may easily assume a position were the central slot 53 is immediately adjacent the body to be peeled in some cases it may not be necessary to limit the degree of pivot. Limitation of pivot, for example, can be had by making the small diameter cylindrical member 141 in a shape which is not completely cylindrical or some other expedient.

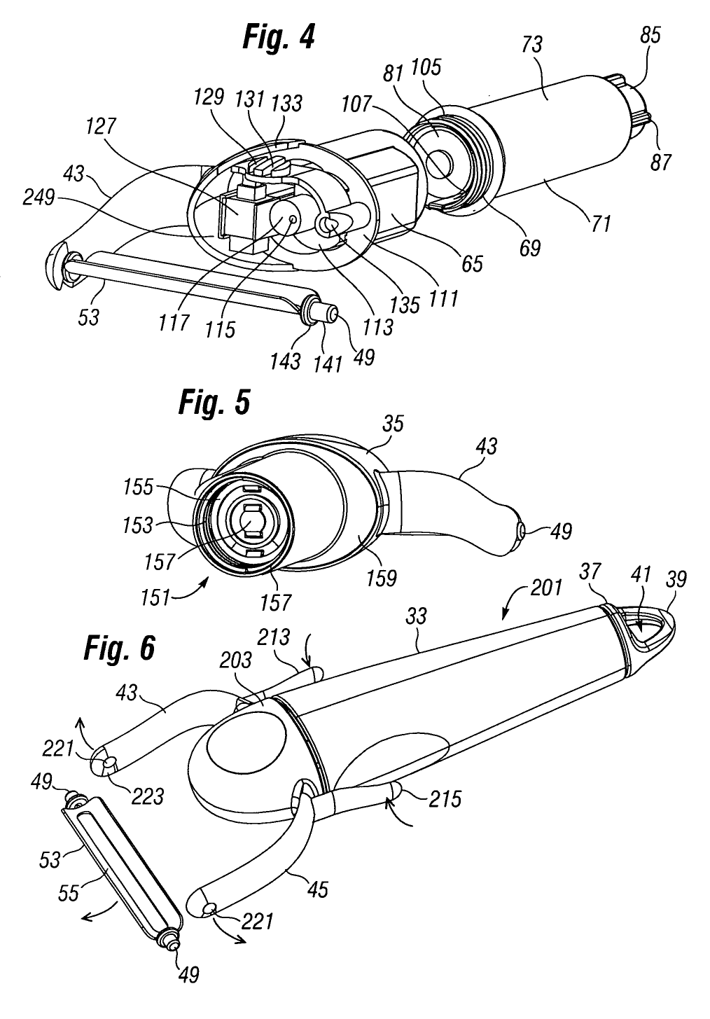

Referring to FIG. 5, a view looking into the rear of the forward housing with the battery housing 73 detached as in FIG. 4 illustrates details for mechanical and electrical connection of the battery housing 73 both physically and electrically to the forward housing 35. An opening 151 includes a threaded section 153 has threads which are compatible with the threaded section 105 located on the battery housing 73. A conductive outer contact ring 155 extends around the inner periphery of the opening 151 and is for contacting the end of the conductor strip 83 when the battery housing 73 is threadably attached to the motor housing 65. A conductive inner contact 157 is positioned to contact forward side of the battery 81 when the when the battery housing 73 is threadably attached to the motor housing 65. Since joinder will be had by turning, the contacts 155 and 157 are arranged to facilitate contact regardless of the angular turned relationship of the battery housing onto the motor housing 65. An abutment rim 157 is sized to compress the “o” ring seal 69 to provide a watertight seal between the motor housing 65 and the battery housing 73. Also seen is a rear abutment surface 159 for abutting the forward end of the handle member 33.

To disassemble the vibrating peeler, the end closure 37 is unscrewed and set aside. This allows the handle member 33, perhaps with integral damper 75 and damper washer 91 connected, to be removed away from the end of the battery housing 73 and projection 85. Removal of the handle member 33 allows access to and the ability to separate handle member 33 from motor housing 65, especially to change the batteries 81. Such access is also facilitated for cleaning and washing. For reassembly, the reverse steps are performed. It should be noted that the damper washer 91 simply protects the Damper from damage which might otherwise be caused by the end closure 37. Generally, the damper 75 functions to position the handle member 33 relative to the battery housing 73 and the damper 75 may be slightly compressed by the end closure 37. Varying compression ratios allow the amount of damping to be adjusted. Indexation between the end closure 37 and the damper washer 91 could allow adjustable, selection of preferred damping.

Referring to FIG. 6, a second embodiment is seen as a vibrating peeler 201 having a different forward housing 203 which includes a pair of rearwardly projected levers. Lever 213 is connected to and extends rearwardly of arm 43. Lever 215 is connected to and extends rearwardly of arm 45. When the lever arms 213 and 215 are pressed toward each other and toward the handle member 33, the arms 43 and 45 open to release the double blade 53. This technique helps isolate the user even more so from having to touch the double blade 53. The removed position of the double blade 53 also exposes a pair of pivot apertures 221. A shallow internal depression 223 may be present to help users approach a double blade 53 when the double blade 53 is sitting on a table or other flat surface, and facilitates manipulation of the arms 43 and 45, whether or not the lever arms 213 and 215 are present.

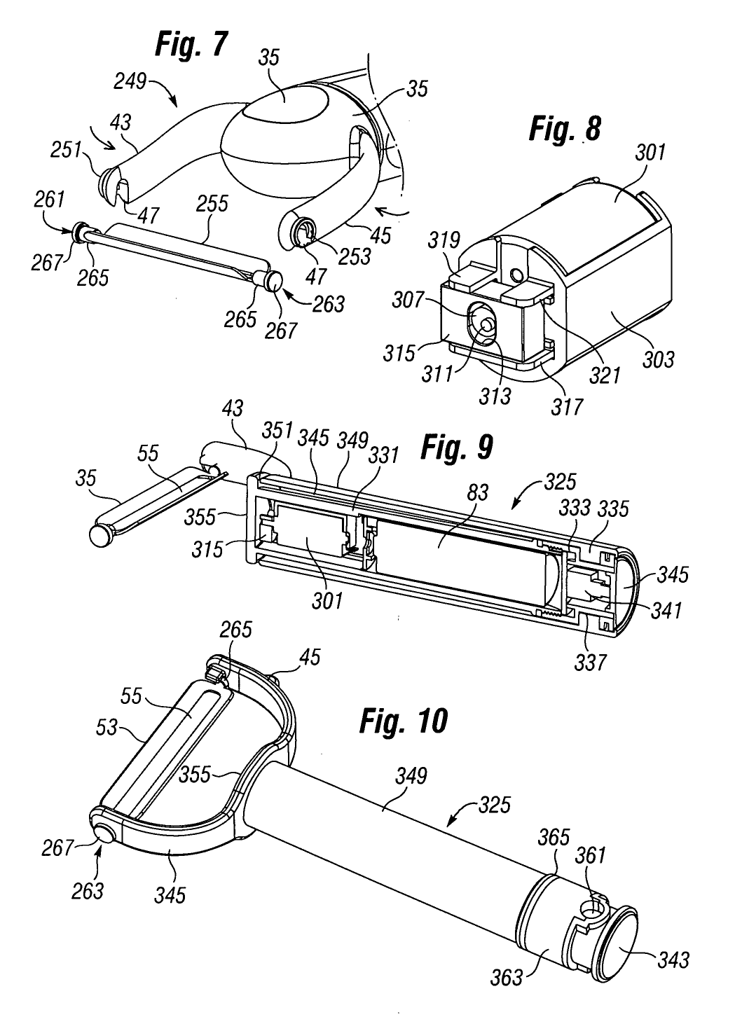

Referring to FIG. 7 an alternative embodiment is seen as a peeler 249 in which the pivot arms 43 and 45 can be urged together to release the peeler blade. Arms 43 and 45 have external bosses 251 and 253 which are meant to engage a double blade 255. The double blade 255 includes a pair of pivot fittings 261 and 263. The pivot fittings 261 and 263. Each of the pivot fittings 261 and 263 has cylindrical portion 265 which is inboard of an outer expanded head 267.

Referring to FIG. 8 a perspective view of a motor 301 and support frame 303 which can operate with respect to a further embodiment is shown. The embodiments of FIGS. 1-7 have shown an eccentric weight 117 which provides a circular vibration. The optimum desired vibrating motion is in a direction parallel to the sharpened edges adjacent the central slot 55 of the double blade 53. Motion which tends to lift and drop the double blade 55 is generally wasted. The energy used for circular vibration is more than that which would be used for vibration in one direction.

Whereas eccentric weight 117 caused an operation based upon its own mass, an eccentric cam 307 rotates with a shaft 311 within a generally vertical slot 313 within a rectangular shaped mass 315. Thus the eccentric arrangement is one in which the predominant vibrational movement is from side to side. Rectangular shaped mass 315 moves to the left and right within a travel track made up of a lower plate 317 and a pair of upper plates 319 and 321. Eccentric cam 307 may be standard or may be specially constructed to have very little or minimum mass. In any event, the mass of the rectangular shaped mass 315 will predominate and the majority of the vibration will occur along the planes of the plates 317, 319 and 321. The amount of up and down vibration from the mass of the eccentric cam 307 will be negligible.

FIG. 9 is a side sectional view of a fourth embodiment which can utilize the motor arrangement seen in FIG. 8. Since the predominant motion is side to side, any damping should also take account of this predominant mode. A half section of a vibrating peeler 325 illustrates dampener which operates about a vertical pivot to work with the side to side motion produced. Motor 301 fits within a sleeve 331 which threadably connects to a receiver 333. The receiver 333 is attached to a pivot fitting including a top pivot fitting 335 and a bottom pivot fitting 337. A switch 341 is in a position to be operated by an on/off button located at the rear of the vibrating peeler 325. Note that a gap 345 exists between the sleeve 331 and an outer housing 349. Note that the arm 43 is attached to the sleeve 331 and that the end of the sleeve 331 is attached to the arm 43. In this configuration, the bulk of the side to side motion is transmitted directly to the arms 43 and 45, and thence to the double blade 55, while the user holds the outer housing 349. The user essentially supports the vibrating structure from a rear pivot while holding the outer housing 349. The gap 345 as a longitudinal space continues at it turns and becomes a gap 351 adjacent the front plate 355 of the sleeve 331.

Referring to FIG. 10, a perspective external view of the fourth embodiment illustrating some of the features seen in FIGS. 8 and 9. In addition, an external top pivot structure 361 is seen. An Expanded portion forms a battery cap 363. The rearward actuation enables the switch assembly including switch 341 and on/off button 343 to be rearwardly actuated and removed along with the battery cap. The battery cap 363 is attached using an “o” ring structure 365. Damping structures can be employed, but since the sleeve 331 operates as a pivot, no truly motion resistive structures are believed to be necessary. So long as the sleeve 331 has no vibrational source of noise with respect to the outer housing 349. Further, without the constraint of an energy absorbing dampener a significantly greater vibrational displacement is achieved. Every feature of every one of the vibrating peeler 31, 201, 249, 325 can be used with every other one of the vibrating peeler 31, 201, 249, 325.

While the present invention has been described in terms of a structure, device and process for creating and delivering a vibrational force and motion to a peeler blade, and particularly a structure which breaks down for easy cleaning, as well as a mechanism for producing vibration predominantly in a plane parallel to the peeler blade, one skilled in the art will realize that the structure and techniques of the present invention can be applied to many structures and devices which are used in the kitchen, and particularly where motion is to be applied to an instrument for preparing and processing food in a fine manner and to enable precision peeling to enhance controllability and the fine appearance of the food product processed and treated by such device.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A vibrating peeler comprising:
a main housing having a pair of spaced apart arms extending from the main housing;
an electric motor supported within the main housing and having a rotatable shaft;
an eccentric arrangement mechanically driven by the rotatable shaft to provide a vibration to the main housing when the motor is energized;
a battery housing having a first end attached to the main housing and having batteries electrically connected to the electric motor and a second end;
a blade carried between the pair of spaced apart arms;
a handle member surrounding the battery housing having a first end adjacent the main housing and a second end; and
an attachment member connected between the second end of the battery housing and the first end of the handle member.

2. The vibrating peeler as recited in claim 1 wherein the attachment member includes a damper.

3. The vibrating peeler as recited in claim 1 wherein the attachment member includes a pivot.

4. The vibrating peeler as recited in claim 1 wherein the attachment member includes an end closure which engages a member attached to the battery housing and abuts the handle member.

5. The vibrating peeler as recited in claim 4 wherein the attachment member includes a damper.

6. The vibrating peeler as recited in claim 1 wherein the end closure supports a vegetable eye remover.

7. The vibrating peeler as recited in claim 1 wherein the eccentric arrangement is for producing a vibration predominantly linearly between the pair of spaced apart arms.

8. The vibrating peeler as recited in claim 1 wherein the blade is a double blade having a central slot with sharpened edges on either side of the central slot.

9. The vibrating peeler as recited in claim 1 wherein each of the pair of spaced apart arms carries a slot for engaging each end of the blade and wherein the blade is detachable from the pair of spaced apart arms by applying force normal to a line between the pair of spaced apart arms.

10. The vibrating peeler as recited in claim 1 where the blade is pivotably supported by the pair of spaced apart arms.

11. The vibrating peeler as recited in claim 1 wherein each of the pair of spaced apart arms may be deflected in a direction away from each other for disengaging and re-attaching the blade.

12. The vibrating peeler as recited in claim 11 and further comprising a pair of lever arms, each one of the lever arms attached to an associated one of the pair of spaced apart arms such that the pair of spaced apart arms may be deflected in a direction away from each other by deflecting the pair of lever arms toward each other to facilitate to disengagement or attachment of the blade.

13. The vibrating peeler as recited in claim 1 wherein each the pair of spaced apart arms may be deflected in a direction toward from each other to disengage or attach the blade.

14. The vibrating peeler as recited in claim 1 wherein the battery housing is threadably engaged to the main housing and includes a compressible dampener compressed between the battery housing and the main housing.

15. The vibrating peeler as recited in claim 1 and further comprising a switch interposed between the batteries and the electric motor, to switch the vibrating peeler on and off, the switch supported by the main housing.

16. A vibrating peeler comprising:
a main housing having a pair of spaced apart arms extending from the main housing;
an electric motor supported within the main housing and having a rotatable shaft;
an eccentric arrangement mechanically driven by the rotatable shaft to provide a vibration to the main housing when the motor is energized;
a battery housing attached to the main housing and having batteries electrically connected to the electric motor;
a blade carried between the pair of spaced apart arms;
a handle member surrounding the battery housing; and
a damper interposed between the handle member and the battery housing.

17. A vibrating peeler comprising:
a main housing having a pair of spaced apart arms extending from the main housing;
an electric motor supported within the main housing and having a rotatable shaft;
an eccentric member attached to the rotatable shaft to provide a vibration to the main housing when the motor is energized;
a battery housing attached to the main housing and having batteries electrically connected to the electric motor;
a blade carried between the pair of spaced apart arms;
a handle member surrounding the battery housing; and
a pivot interposed between the handle member and the battery housing.
